(19) United States
(12) Patent Application Publication
(10) Pub. No.: US 2013/0058506 A1
(43) Pub. Date: Mar. 7, 2013

(54) Microphone Buffer Circuit With Input Filter

(71) Applicant: Steven E. Boor, Plano, TX (US)

(72) Inventor: Steven E. Boor, Plano, TX (US)

(21) Appl. No.: 13/546,731

(22) Filed: Jul. 11, 2012

Related U.S. Application Data
(60) Provisional application No. 61/506,715, filed on Jul. 12, 2011.

(51) Int. Cl. H04R 3/00

(52) U.S. Cl. 381/122

(57) ABSTRACT

A buffer circuit includes a buffering portion, an active resistor, and a control portion. The buffering portion is configured to receive a signal from a microphone. The active resistor is coupled to the buffering portion and the control portion is coupled to the active resistor. The control portion is configured to selectively activate or deactivate the active resistor. When the active resistor is activated, the active resistor and a capacitance of the microphone form a high pass filter. The high pass filter is effective to filter noise from the signal received from the microphone by the buffering portion.

### CROSS REFERENCE TO RELATED APPLICATIONS

This patent claims benefit under 35 U.S.C. §119 (e) to U.S. Provisional Application No. 61/506,715 entitled “Microphone Buffer Circuit With Input Filter” filed Jul. 12, 2011, the content of which is incorporated herein by reference in its entirety.

### TECHNICAL FIELD

This application relates to microphones and, more specifically, to buffer circuits associated with these microphones.

### BACKGROUND OF THE INVENTION

Various types of microphone systems have been used in various applications through the years. Microphones in these systems typically receive acoustic energy and convert this acoustic energy into an electrical voltage signal. This voltage signal can be further processed by other applications or for other purposes. For example, in a hearing aid system the microphone may receive acoustic energy, and convert the acoustic energy to an electrical voltage signal. The voltage signal may be amplified or otherwise processed by an amplifier, or by other signal processing electronics circuitry, and then presented by a receiver as acoustic energy to a user or wearer of the hearing aid. To take another specific example, microphone systems in cellular phones typically receive sound energy, convert this energy into a voltage signal, and then this voltage signal can be further processed for use by other applications. Microphones are used in other applications and in other devices as well.

Recent advances in digital hearing instrument technology have appreciably improved the listening experience of hearing impaired users. However, one area of continued concern involves when these users are listening to sounds in noisy outdoor listening conditions, such as can be caused by the wind. The wind can create interference such that the listener has difficulty hearing the sounds they wish to hear. Previous approaches have sometime attempted to reduce or eliminate this problem, but have been unsuccessful for a variety of different reasons.

### BRIEF DESCRIPTION OF THE DRAWINGS

For a more complete understanding of the disclosure, reference should be made to the following detailed description and accompanying drawings wherein:

FIG. 1 comprises a block diagram of an acoustic system according to various embodiments of the present invention;

FIG. 2 comprises a circuit diagram of one example of a buffer circuit according to various embodiments of the present invention;

FIG. 3 comprises another example of a buffer circuit according to various embodiments of the present invention;

FIG. 4 comprises a graph showing the Drain Current vs. Drain Voltage performance characteristics of an Enhancement NMOS transistor, for a fixed Gate voltage and a grounded Source voltage, according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Approaches are provided that improve the listening experience of users of hearing instruments by reducing or eliminating the effects of wind noise and other types of low frequency interference. A high pass filter (HPF) function is provided and portions of this function are incorporated into a buffer circuit. In so doing, low frequency interference (e.g., noise caused by wind) is automatically removed from a signal of interest while, at the same time, other buffer functions are still provided to the user.

In one aspect, at least some portions of a High Pass Filter (HPF) network are incorporated directly into microphone buffer circuitry, so as to reduce the negative affects that wind noise interference can have on the quality of the listening experience for hearing instrument (or other) users. Introduction of such a high pass filter as a wind noise filter can be achieved, in one example, via the use of an enhancement NMOS transistor that is configured as an “active resistor” with its Drain and Source terminals connected between a microphone buffer input terminal and an appropriate DC voltage reference in the circuit.

In many of these approaches, the appropriate electrical Gate terminal biasing for the “active resistor” is such that it sets the effective resistance of the device to a value which induces an electrical HPF function. This, in turn, attenuates the low frequency content of any wind noise interference directly at the input terminal of the microphone buffer circuit. In one advantage, the HPF network helps to prevent the buffer circuit input terminal from being electrically overloaded by wind noise interference. In other advantages, the approaches described herein allow downstream signal processing by, for example, a hearing instrument digital signal processor (DSP) to readily remove additional wind noise content at low frequencies, while maintaining much improved audio signal quality during the wind noise interference event as compared to previous microphones (which as mentioned were often overloaded by low frequency wind noise interference).

In some aspects, the “active resistor” (e.g., the enhancement NMOS transistor) can be controlled to provide a fixed or an adjustable resistance, and consequently, to implement either a fixed, variable, or adaptable HPF cutoff (or corner) frequency for the high pass filter. In other aspects, the wind noise filter can be turned on/off via a control signal. The capability of turning on/off the wind noise filter feature is often advantageous, since low resistance values for the “active resistor” (e.g., that will set a relatively high HPF cutoff frequency, which is highly effective for attenuating wind noise interference) will appreciably degrade the buffer circuit noise performance under quiescent conditions when there is no wind noise interference present. Consequently, the ability to turn off the wind noise filter feature under these quiescent conditions improves the overall microphone Signal-to-Noise Ratio (SNR) performance in the hearing instrument system, when the wind noise filter feature is not needed.

It will be appreciated that although the descriptions herein relate to removing wind noise, it will be appreciated that these approaches can be used to substantially reduce any type of low frequency noise interference, no matter what the source.

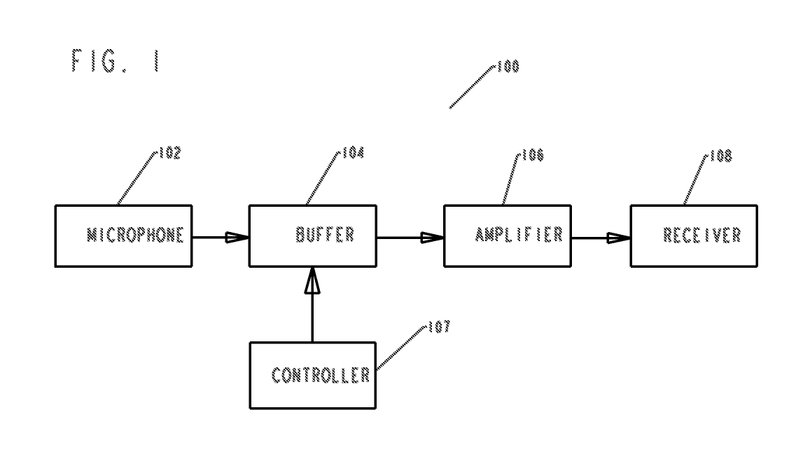

Referring now to FIG. 1, one example of an audio system 100 includes a microphone 102, a buffer 104, an amplifier 106, a controller 107, and a receiver 108. Power is supplied to these elements, for example, from a battery (not shown) or some other energy source.

The microphone 102 may be any microphone (or transducer) that receives acoustic energy and converts this energy to an electrical signal. For example, the microphone 102 may be an electret microphone such as the commercially available FG3629 microphone, sold by Knowles Electronics of Itasca, Ill. Such an electret microphone may include a charged plate (not shown) which is coupled to the gate of an FET (also not shown). The microphone 102 may include a diaphragm and may include micro electromechanical system (MEMS) components.

The amplifier 106 amplifier amplifies the electrical signal for use by the receiver 108. For instance, the amplifier 106 may amplify signals from 6 to 20 dB. Other amplification values are possible.

The controller 107 provides control signals to the buffer 104. For example, the controller 107 provides control signals that activate and deactivate the high pass filtering function that is provided by the buffer 104.

The receiver 108 may be any receiver device such as a speaker. The receiver 108 converts the electrical signal amplified by the amplifier 106 to an amplified sound, for example, for presentation to a user (e.g., the wearer of a hearing aid or some electrical processing application). Other examples of receivers and receiver functions are possible.

The buffer 104 typically lowers the impedance presented by a microphone transducer 102. If the transducer impedance is not lowered, any voltage signals can become substantially attenuated by the loading effects of downstream system electronics and the SNR can be lowered to undesirable levels. A typical microphone transducer impedance of 10 M ohms is lowered by three orders of magnitude (e.g., to 4 K ohms) at the buffer output in one example.

The buffer 104 also provides a HPF function at its input (e.g., it includes at least some portions of a HPF network) and this HPF function may be implemented by an “active resistor” in the buffer. The “active resistor” can be configured and controlled so as to provide a fixed or an adjustable resistance, thereby providing either a fixed or a variable HPF cutoff frequency for the high pass filter function. In some aspects, the filter can be turned on or off via a digital control signal (e.g., from the controller 107). The capability of turning on/off the noise filter feature is often advantageous, since low resistance values for the “active resistor” (i.e., values that will set a relatively high HPF cutoff frequency in the audible listening band, but which are also highly effective for attenuating wind noise interference) might appreciably degrade the buffer circuit noise performance under quiescent conditions when there is no wind noise interference present (i.e., since the cutoff frequency provided by the filter is in the audible frequency band). The ability to turn off the HPF feature under these quiescent conditions will thereby improve the overall microphone SNR performance in the hearing instrument system under normal listening conditions (e.g., when the wind noise filter feature is not needed).

In one example of the operation of the system of FIG. 1, acoustic energy is received at the microphone 102. For example, this acoustic energy may be in the form of human speech, music, or any other sound or combination of sounds. The microphone 102 converts the energy into an electrical signal, and passes it to the buffer. The buffer 104 typically lowers the impedance presented by the microphone 102. The buffer 104 also selectively provides a HPF function and this HPF function provided by the buffer 104 removes interference in the signal received by the buffer 104. More specifically, the buffer 104 is configured to remove signal interference below a HPF cutoff or corner frequency. As described elsewhere herein, this function can be activated and de-activated by an external control source, for example, by controller 107. The buffer 104 then provides the signal to the amplifier 106, which amplifies the signal. From the amplifier 106, the signal is then sent to the receiver 108 where the signal may be further processed.

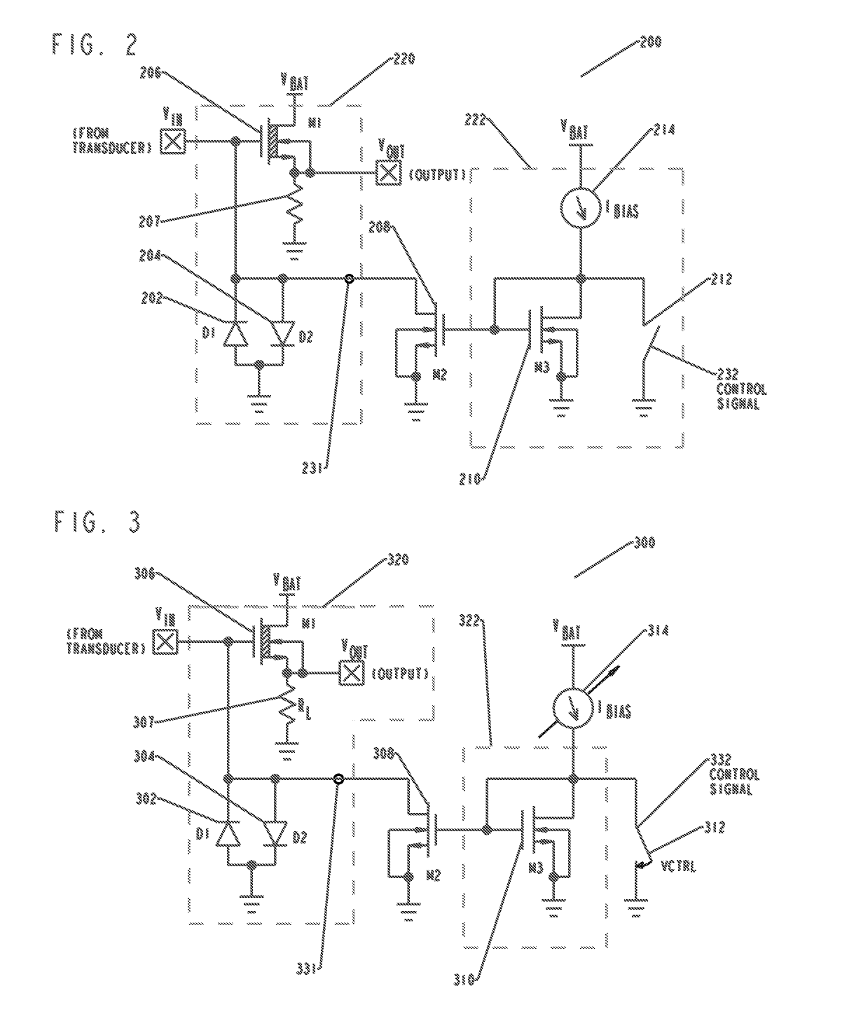

Referring now to FIG. 2, one example of a buffer circuit 200 is described. The buffer circuit 200 includes a first diode (D1) 202, a second diode (D2) 204, a resistor 207 (R_{L}), a first transistor (M1) 206, a second transistor (M2) 208, a third transistor (M3) 210, a switch 212, and a current source I_{BIAS} 214. In one aspect, these components may be disposed on a single semiconductor/MEMS chip that also includes a microphone transducer. A first portion of the circuit 220 provides buffering functions (i.e., reducing the microphone transducer impedance connected to Vᵢₙ); a second portion (including the transistor 208 (M2)) provides an active resistance used in a HPF function at the buffer input; and a third portion 222 controls whether the HPF function is provided. Electrical signals containing audio content are received from the microphone at Vᵢₙ and output at Vₒᵤₜ.

The transistors 206 (M1), 208 (M2), and 210 (M3) are depletion NMOS, enhancement NMOS, and enhancement NMOS transistors, respectively, each having a predefined size. Other types of semiconductor devices or combinations of devices may also be used. The term transistor “size” as used herein means dimensions such as the channel width of the transistor, the channel length of the transistor, and a multiple (i.e., how many transistors may be connected in parallel to form an equivalent transistor). Other parameters may also describe the size of the transistor.

The circuit of FIG. 2 is arranged and selected so as to provide as large of I_{BIAS} current as is suitable for the circuit. I_{BIAS} is selected to be such a suitable value because when the circuit of FIG. 2 is exposed to light, photocurrents will be induced in the circuit and I_{BIAS} should be as large as possible such that the effects of the photocurrents are as negligible as possible. In one example, I_{BIAS} is selected to be a value of current between 1 nA and 100 nA. Other values of I_{BIAS} current are possible.

The switch 212 activates the HPF function of the circuit when the switch 212 is open. When the switch 212 is closed, the HPF function is deactivated. The switch 212 may be controlled by a controller (not shown in FIG. 2) via a control signal 232. In one aspect, a Digital Signal Processor in the system (e.g., a hearing aid system) monitors the amount of low frequency energy. When that Low Frequency energy reaches a certain threshold, it would send the appropriate control signal to activate our Wind Noise Filter feature. Once the Low Frequency energy drops below a lower threshold value, the DSP would detect that the wind noise interference has substantially subsided and it would disable the HPF to allow normal operation.

As mentioned, the transistor 208 (M2) is configured to be an active resistor. The resistance of transistor 208 (M2) substantially becomes an infinite value when the switch 212 is closed and the transistor 210 (M3) is off, effectively becoming an open circuit impedance in its connection at point 231. By “HPF function” and as used herein, it is meant that the transistor 208 (M2) provides a resistance at the buffer circuit input that together with an equivalent capacitance of the microphone transducer provides a high pass filter for electrical signals provided at input Vᵢₙ (and subsequently output at Vₒᵤₜ) and acts to attenuate these signals below a cutoff or corner frequency that is determined by this resistance and capacitance.

When the HPF function is activated (i.e., the switch 212 is open and transistor 210 (M3) is activated), the resistance of transistor 208 (M2) is set by I_{BIAS} and the sizes of the transistors 210 and 212. For example, the channel length, channel width, and multiples of the transistors 210 (M3) and 212 (M2) may be selected to set a particular resistance value for transistor 212 (M2). The effective resistance of the transistor 208 (M2) becomes the resistance for the HPF function. It will be appreciated that the Source terminal of the “active resistor” (transistor 208 (M2)) can be connected to either ground or a non-grounded voltage reference (V_{REF}). The bottom common terminal for diodes D1 and D2 (i.e. their terminals not connected to Vin) will normally be connected to the same bias voltage as that as the Source terminals of transistors 208 (M2) and 210 (M3). The choice of using either GND or a V_{REF} is decided by the circuit designer to allow optimal biasing conditions for the buffer circuit input device 206 (M1). The choice of using either GND or a V_{REF} is decided by the circuit designer to allow optimal biasing conditions for the buffer circuit input device 206 (M1).

As mentioned, the effective resistance provided by the transistor 208 (M2) is determined based upon the bias current (I_{BIAS}) and sizes of the transistors 210 (M3) and 212 (M2). This effective resistance value is quantified by the slope of a curve showing the Drain Current characteristic of transistor 208(M2) for a given I_{BIAS} current, and one example is shown in FIG. 4. In linear regions 402 of the curve, the transistor 208 (M2) acts as a resistor and in the non-linear regions 404 the transistor 208 (M2) acts as a current source. The mathematical inverse of the slope of the curve is the resistance of the transistor 208 (M2). It is desirable to operate the transistor 208 (M2) in the linear region 402. It will be appreciated that changing the I_{BIAS} current which controls the Gate voltage of transistor 208 (M2) changes the resistance of the transistor 208 (M2).

In operation, I_{BIAS} is set and the size parameters of transistors 210 (M3) and 208 (M2) are also set (e.g., both may be set to predetermined values during the design and manufacturing process that constructs the circuit of FIG. 2). Setting these parameters configures a particular Gate voltage for transistor 208 (M2), which in turn configures the transistor 208 (M2) to have a particular effective resistance. The resistance provided by the transistor 208 (M2) at least in part sets the HPF cut off frequency for the HPF function. The capacitance of the microphone transducer connected to the circuit of FIG. 2 at V_{IN} is the capacitance of the HPF function. As mentioned, the switch 212 is used to activate or deactivate the HPF function.

The diodes 202 (D1) and 204 (D2) set the DC bias voltage for the Gate of the buffer input transistor 206 (M1). Resistor 207 (R_{L}) is used to set the gain and the DC bias current of transistor 206 (M1) in the buffer circuit. Typically, resistor 207 (R_{L}) is 22 K ohms, and transistor 206 (M1) has a channel length of 3.6 um, a width of 100 um, and a multiple of 1. The DC bias current of transistor 206 (M1) is typically about 25 uA, and the buffer output impedance is about 4 K ohms. When the HPF feature is activated (i.e. switch 212 is open), transistor 208 (M2) reduces the buffer input impedance, for example, from 10 Tera ohms to 320 Mega ohms, which substantially sets the HPF corner frequency well within the audio frequency band and attenuates low frequency signals from the microphone transducer. With the filter function deactivated (i.e., switch 212 is closed), diodes 202 (D1) and 204 (D2) set the buffer input impedance typically at 10 Tera ohms and no HPF function is active at the buffer input to attenuate any signals coming from the microphone transducer.

In one example, the above approaches are used to configure the transistor 208 (M2) to have an effective resistance of 320 Mega ohms and this value is effective to attenuate all signals less than approximately 500 Hz. In one example and to achieve these results, I_{BIAS} (214) is 1 nA, the channel length of transistor 208 (M2) is 5 um, the channel width is 20 um, and the multiple is 1, while the channel length of transistor 210 (M3) is 5 um, the channel width is 20 um, and the multiple is 10. Other numeric values for these parameters are possible.

In some applications when the transistor 208 (M2) is active, the impedance of the transistor 208 (M2) is low enough to provide a cutoff frequency in the audio band (e.g., 500 Hz). With wind or other noise this is typically not a problem for the intelligibility of human speech, so the control signal 232 is used to turn on the HPF function when needed (e.g., when there is wind noise) and turn off the function when not needed (e.g., when there is no wind noise). The present approaches are controllable since the HPF function is alternatively on or off, and is not on or off all of the time. Thus, the present approaches are effective to reduce low frequency noise interference when needed (e.g., when it is windy) and can be turned off when not needed (e.g., when it is not windy).

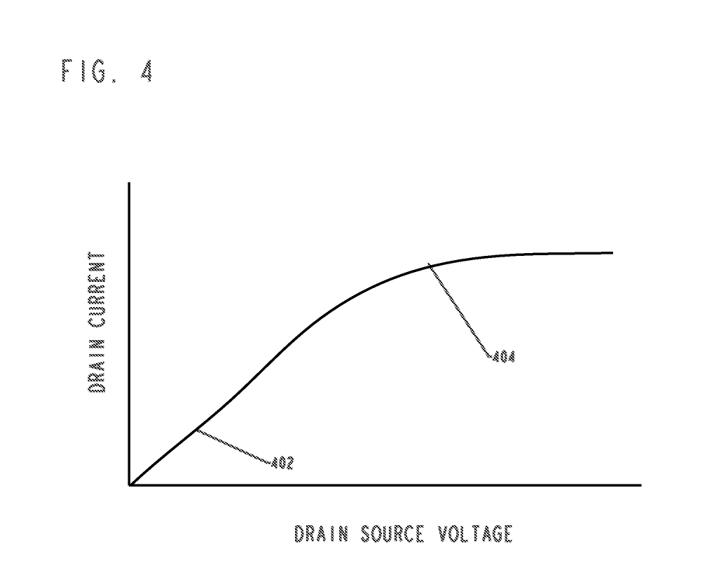

Referring now to FIG. 3, another example of a buffer circuit is described. The buffer circuit 300 includes a first diode (D1) 302, a second diode (D2) 304, a resistor 307 (R_{L}), a first transistor (M1) 306, a second transistor (M2) 308, a third transistor (M3) 310. In one aspect, these components may be disposed on a single semiconductor/MEMS chip that may also include a microphone transducer. External to this chip is provided both a switch 312 and an adjustable current source I_{BIAS} 314. The external switch 312 controls whether the HPF function is provided. A first portion of the circuit 320 provides buffering functions (i.e., reducing the impedance provided by the microphone transducer connected to Vin); a second portion (including the transistor 308 (M2)) provides an active resistance used in a HPF function at the buffer input; and a third portion 322 set the value of the effective resistance value of transistor 308 (M2) if the switch 312 does not deactivate the HPF function. Electrical signals containing audio content are received from the microphone transducer at Vᵢₙ and output at Vₒᵤₜ.

The transistors 306 (M1), 308 (M2), and 310 (M3) are depletion NMOS, enhancement NMOS, and enhancement NMOS transistors, respectively, each having a predefined size. Other types of devices or combinations of devices may also be used. The term transistor “size” as used herein means dimensions such as the channel width of the transistor, the channel length of the transistor, and a multiple (i.e., how many transistors may be connected in parallel to form an equivalent transistor). Other parameters may also describe the size.

The transistor 308 (M2) is configured to be an active resistor. When the HPF function is activated (i.e., I_{BIAS} is turned on and the switch 312 is open), the resistance of transistor 308 is set by the value of I_{BIAS} and the sizes of the transistors 310 (M3) and 308 (M2). For example, the channel length, channel width, and multiples of the transistors 310 (M3) and 308 (M2) may be selected. The effective resistance of the transistor 308 (M2) becomes the resistance of the HPF function. The Source terminals of the “active resistor” (transistor 308 (M2)) and transistor 310 (M3) can be connected to either ground or a non-grounded voltage reference (V_{REF}). The bottom common terminal for diodes D1 and D2 (i.e. their terminals not connected to Vin) will normally be connected to the same bias voltage as that as the Source terminals of transistors 308 (M2) and 310 (M3).

In operation, I_{BIAS} is set by a controller (not shown in FIG. 3) via a control signal 330 and the size parameters of transistors 310 (M3) and 308 (M2) are also set (e.g., during the design and manufacturing process that constructs the circuit of FIG. 3). Setting I_{BIAS} and these size parameters configures a particular Gate voltage for transistor 308 (M2), which in turn provides a particular effective resistance for the transistor 308 (M2). The resistance provided by the transistor 308 (M2) at least in part sets the HPF cut off frequency for the high pass filter function while the capacitance of the transducer (connected to the input, V_{IN}, of the buffer circuit 300 of FIG. 3) is the capacitance used to set the HPF function.

The diodes 302 (D1) and 304 (D2) set the DC bias voltage of the Gate of buffer input transistor 306 (M1). Resistor 307 (R_{L}) is used to set the gain and the DC bias current of transistor 306 (M1) in the buffer circuit. Typically, resistor 307 (R_{L}) is 22 K ohms, and transistor 306 (M1) has a channel length of 3.6 um, a width of 100 um, and a multiple of 1. The DC bias current of transistor 306 (M1) is typically about 25 uA, and the buffer output impedance is about 4 K ohms. When the HPF feature is activated (i.e. switch 312 is open), transistor 308 (M2) reduces the buffer input impedance, for example, from 10 Tera ohms to 320 Mega ohms, which substantially sets the HPF corner frequency well within the audio band and attenuates low frequency signals from the microphone transducer. With the HPF function deactivated (I_{BIAS} is off and/or switch 312 is closed), the diodes 302 (D1) and 304 (D2) set the buffer input impedance typically to 10 Tera ohms, and no HPF function is active at the buffer input to attenuate any signals coming from the microphone transducer.

In one example, transistor 308 (M2) is 320 Mega ohms and this attenuates all signals less than approximately 500 Hz. In one example, the external bias current I_{BIAS} (314) is 1 nA, the channel length of transistor 308 (M2) is 5 um, the channel width is 20 um, and the multiple is 1, while the channel length of transistor 310 (M3) is 5 um the channel width is 20 um, and the multiple is 10. Other numeric values for these parameters are possible.

It will be appreciated that the buffer of FIG. 3 provides an HPF with an adjustable corner frequency which can also be externally activated and deactivated. The HPF deactivation is provided by turning off I_{BIAS} (e.g., setting I_{BIAS}=0) and/or externally controlling a switch to connect signal node V_{ctrl} to ground (e.g., by closing the switch 312). Actuation of the switch 312 and the adjusting of the I_{BIAS} current may automatically be controlled by a controller.

In operation, the adjustable I_{BIAS} current 314 and the switch 312 are located off the buffer chip and outside of the microphone. To deactivate the HPF function, the switch 312 should be closed via a control signal 332 to robustly ensure that both the transistor 308 (M2) and the transistor 310 (M3) are deactivated (the I_{BIAS} current can either be left turned on or turned off, since it is typically a very small current of only about 1 nA). I_{BIAS} 314 is used to set the voltage at the Gate of transistor 308 (M2), which controls its effective resistance. This voltage is adjustable (by adjusting the value of the current of I_{BIAS}) and as the voltage at the Gate of transistor 308 (M2) changes, the resistance of transistor 308 (M2) changes. For example, an I_{BIAS} value of 100 nA may yield a resistance of transistor 308 (M2) of 3 Mega ohms. Hence, as the value of I_{BIAS} is increased, the effective resistance of transistor 308 (m2) decreases, and the HPF corner frequency is also increased which will cause further attenuation of wind noise and/or other low frequency interference.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A buffer circuit comprising:
a buffering portion, the buffering portion configured to receive a signal from a microphone;
an active resistor coupled to the buffering portion;
a control portion, the control portion coupled to the active resistor, the control portion being configured to selectively activate or deactivate the active resistor;
such that when the active resistor is activated, the active resistor and a capacitance of the microphone form a high pass filter, the high pass filter being effective to filter noise from the signal received from the microphone by the buffering portion.

2. The buffer circuit of claim 1 wherein when the active resistor is deactivated, a high pass filter is not formed with elements of the microphone.

3. The buffer circuit of claim 1 wherein the control portion further comprises a switch that controls activation and deactivation of the active resistor.

4. The buffer circuit of claim 2 wherein the switch selectively activates and deactivates the high pass filter.

5. The buffer circuit of claim 1 wherein the active resistor is an NMOS transistor.

6. An acoustic device, the acoustic device comprising:
a microphone;
a buffer circuit coupled to the microphone, the buffer circuit comprising:
a buffering portion, the buffering portion configured to receive a signal from the microphone;
an active resistor coupled to the buffering portion;
a control portion, the control portion coupled to the active resistor, the control portion being configured to selectively activate or deactivate the active resistor;
such that when the active resistor is activated, the active resistor and a capacitance of the microphone form a high pass filter, the high pass filter being effective to filter noise from the signal received from the microphone by the buffering portion and provide a noise-reduced signal.

7. The acoustic device of claim 6 wherein the active resistor is an NMOS transistor.

8. The acoustic device of claim 6 further comprising an amplifier that is coupled to an output of the buffer circuit, the amplifier configured to receive the noise-reduced signal.

9. The acoustic device of claim 8 further comprising a speaker, the speaker being coupled to the amplifier.
